(19) United States
(12) Patent Application Publication
(10) Pub. No.: US 2018/0258213 A1
(43) Pub. Date: Sep. 13, 2018

(54) Curing Method for Polyurethanes

(71) Applicants: Henkel AG & Co. KGaA, Duesseldorf (DE); Max-Planck-Gesellschaft Zur Foerderung Der ..., Muenchen (DE)

(72) Inventors: Andreas Taden, Duesseldorf (DE); Stefan Kirschbaum, Leverkusen (DE); Jan-Erik Damke, Duesseldorf (DE); Katharina Landfester, Mainz (DE)

(21) Appl. No.: 15/976,993

(22) Filed: May 11, 2018

Related U.S. Application Data
(63) Continuation of application No. PCT/EP2016/076331, filed on Nov. 2, 2016.

(30) Foreign Application Priority Data
Nov. 11, 2015 (EP) 15194065.7

(51) Int. Cl. C08G 18/48; C08G 18/73; C09J 175/14; C08J 3/24

(52) U.S. Cl. CPC C08G 18/4854; C08G 18/4808; C08J 3/24; C09J 175/14; C08G 18/73

(57) ABSTRACT

The present invention relates to methods for curing alkenyl ether groups-containing polyurethanes with moisture-reactive end groups by means of a two-stage curing process. The invention further relates to alkenyl ether group-containing polyurethanes with silicon-containing end groups as well as to the cured polymers which can be obtained by means of the method according to the invention and to the products containing them.

The present invention relates to methods for curing alkenyl ether group-containing polyurethanes having moisture-reactive end groups (rVEPU) by means of a two-stage curing process. The invention further relates to alkenyl ether group-containing polyurethanes having silicon-containing end groups, as well as to the cured polymers which can be obtained by means of the method according to the invention and to the products containing them.

Known methods for curing UV-curable polyurethanes are predominantly based on radical polymerization (such as acrylate-functionalized polyurethanes). Radical mechanisms of this kind are disadvantageous in that they are sensitive to oxygen, i.e. the presence of oxygen can inhibit the reaction, which is severely disadvantageous in particular for thin film applications and coatings.

As alternatives, alkenyl ether group-containing polyurethanes are known which can be cured by means of cationic polymerization (Kirschbaum et al., Angew. Chem. Int. Ed. 2015, 54, 5789-5792). Cationic UV curing makes it possible to provide “dark cure” properties, i.e. following a short pulse of radiation, which is required for activation and starts the polymerization or curing, the reaction continues without any further radiation, i.e. independently of the UV radiation source. After starting, the reaction can therefore continue in the dark (=dark cure) or on a production line, which is a significant advantage in particular for adhesive applications, e.g. in fully automated processes. It is disadvantageous, however, that even low amounts of nucleophilic compounds can disrupt the course of the reaction. Said nucleophilic compounds, such as water, can enter into the compositions through the environment or can even be provided by the surfaces of substrates to be coated or bonded.

In contrast with cationic polymerization, moisture-dependent curing is usually very slow and requires time periods of several hours or even days depending on the rate of diffusion of the water molecules, which can depend on a range of factors, such as the hydrophilia and morphology of the material, the environmental conditions, the thickness of the material and the available surface area. This is disadvantageous with respect to the fact that the corresponding compositions exhibit low initial strength and it takes a very long time until they gel or solidify, which is disadvantageous in particular in the case of compositions which initially have low viscosity and are prone to merging.

There is thus a need for a method for curing polyurethanes that is improved with respect to the prior art and overcomes the above-mentioned disadvantages, as well as a need for polyurethanes which can be used in such methods.

It has been found that these disadvantages can be overcome by means of a two-stage curing process and using alkenyl ether group-containing polyurethanes having moisture-reactive end groups (rVEPU). In this curing method, in a first step, a cationic polyaddition reaction of the alkenyl ether groups, initiated by radiation, is carried out and, in a subsequent, second step, a polycondensation reaction of the end groups is carried out, which is moisture-dependent.

A first object of the present invention is therefore a method for cross-linking or curing an alkenyl ether group-containing polyurethane polymer having moisture-reactive end groups, wherein the moisture-reactive end groups are isocyanate groups (—NCO) or silane groups, in particular those of formula —[(CH₂)ₚ—Si(R¹)_{3-q}(OR²)_{q}]ᵣ where p, q and r=1, 2 or 3, R¹=C₁₋₄ alkyl or —(CH₂)ₚ—Si(R¹)_{3-q}(OR²)_{q} and R²=C₁₋₄ alkyl, wherein the polyurethane can be obtained by reacting at least one alkenyl ether polyol containing at least one alkenyl ether group, in particular a 1-alkenyl ether group, and at least two hydroxyl groups (—OH) with at least one polyisocyanate containing at least two isocyanate groups (—NCO), wherein the polyisocyanate, with respect to the isocyanate groups, is used in molar excess relative to the hydroxyl groups in order to obtain an NCO-terminated polyurethane, and optionally the subsequent reaction of the NCO-terminated polyurethane with a silane, in particular with a silane of formula X—[(CH₂)ₚ—Si(R¹)_{3-q}(OR²)_{q}]ᵣ, where X is an NCO-reactive group, wherein, in a first step, the alkenyl ether groups are cationically cross-linked by exposure to radiation and, in a second step, the moisture-reactive groups are polymerized in a moisture-dependent manner.

A further object of the invention is polyurethane polymers having alkenyl ether group-containing side chains and silicon-containing end groups, in particular those of formula —[(CH₂)ₚ—Si(R¹)_{3-q}(OR²)_{q}]ᵣ where p, q and r=1, 2 or 3, R¹=C₁₋₄ alkyl or —(CH₂)ₚ—Si(R¹)_{3-q}(OR²)_{q} and R²=C₁₋₄ alkyl, wherein the polyurethanes can be obtained by reacting at least one alkenyl ether polyol containing at least one alkenyl ether group, in particular a 1-alkenyl ether group, and at least two hydroxyl groups (—OH) with at least one polyisocyanate containing at least two isocyanate groups (—NCO), wherein the polyisocyanate, with respect to the isocyanate groups, is used in molar excess relative to the hydroxyl groups in order to obtain an NCO-terminated polyurethane, and the subsequent reaction of the NCO-terminated polyurethane with a silane, in particular a silane of formula X—[(CH₂)ₚ—Si(R¹)_{3-q}(OR²)_{q}]ᵣ, where X is an NCO-reactive group, preferably an amino or hydroxyl group, in particular an amino group.

The present invention is further directed to the cured or cross-linked polymers which can be obtained in accordance with a method according to the present invention.

“Alkenyl ether polyol”, as used herein, refers to compounds containing at least one group of formula —O-alkenyl, which is bonded to a carbon atom, and at least two hydroxyl groups (—OH). It is preferable for the alkenyl ether polyol to comprise an organic group to which both the alkenyl ether group and the hydroxy groups are bonded, i.e. the hydroxy groups are not bonded to the alkenyl group. It is further preferable for the alkenyl ether group to be a 1-alkenyl ether group, i.e. the C—C double bond is adjacent to the oxygen atom. Vinyl ethyl groups, i.e. groups of formula —O—CH═CH₂, are most particularly preferred.

The term “alkyl”, as used herein, refers to a linear or branched, unsubstituted or substituted saturated hydrocarbon group, in particular groups of formula CₙH₂ₙ₊₁. Examples of alkyl groups include, without being limited thereto, methyl, ethyl, n-propyl, iso-propyl, n-butyl, 2-butyl, tert-butyl, n-pentyl, n-hexyl and similar. “Heteroalkyl”, as used herein, refers to alkyl groups in which at least one carbon atom is replaced by a heteroatom, such as in particular oxygen, nitrogen or sulfur. Examples include, without limitation, ether and polyether, for example diethyl ether or polyethylene oxide.

The term “alkyl”, as used herein, refers to a linear or branched, unsubstituted or substituted saturated hydrocarbon group containing at least one C—C double bond.

“Substituted”, as used herein in particular in connection with alkyl and heteroalkyl groups, refers to compounds in which one or more carbon and/or hydrogen atoms are replaced by other atoms or groups. Suitable substituents include, without being limited thereto, —OH, —NH₂, —NO₂, —CN, —OCN, —SCN, —NCO, —NCS, —SH, —SO₃H, —SO₂H, —COOH, —CHO and similar.

The term “organic group”, as used herein, refers to any organic group containing carbon atoms. Organic groups may be derived in particular from hydrocarbons, it being possible for any carbon and hydrogen atoms to be replaced by other atoms as desired. Organic groups within the meaning of the invention contain 1 to 1000 carbon atoms in various embodiments.

“Epoxide”, as used herein, refers to compounds containing an epoxide group.

“Cyclic carbonate”, as used herein, refers to ring compounds containing the group —O—C(═O)—O— as the ring component.

The term “alcohol” refers to an organic compound containing at least one hydroxyl group (—OH).

The term “amine” refers to an organic compound comprising at least one primary or secondary amino group (—NH₂, —NHR).

The term “thiol” or “mercaptan” refers to an organic compound containing at least one thiol group (—SH).

The term “carboxylic acid” refers to a compound containing at least one carboxylic group (—C(═O)OH).

The term “derivative”, as used herein, refers to a chemical compound that is altered with respect to a reference compound by means of one or more chemical reactions. In connection with the functional groups —OH, —COOH, —SH and —NH₂ and/or the compound classes of the alcohols, carboxylic acids, thiols and amines, the term “derivative” includes in particular the corresponding ionic groups/compounds and salts thereof, i.e. alcoholates, carboxylates, thiolates and ammonium (quaternary nitrogen) compounds. In connection with the cyclic carbonates, the term “derivative” includes in particular the thio derivatives of the carbonates, which are described in more detail below, i.e. compounds in which one, two or all three oxygen atoms of the grouping —O—C(═O)—O— are replaced by sulfur atoms.

“At least”, as used herein in connection with a numerical value, refers to exactly this numerical value or more. “At least one” therefore means 1 or more, for example 2, 3, 4, 5, 6, 7, 8, 9, 10 or more. In connection with a type of compound, the term does not refer to the absolute number of molecules, but rather to the number of types of substances that fall under the particular umbrella term. For example, “at least one epoxide” therefore means that at least one type of epoxide, but also a plurality of different epoxides, may be contained.

The term “curable”, as used herein, refers to a change in the state and/or structure of a material by chemical reaction, which is usually, but not necessarily, induced by at least one variable, such as time, temperature, moisture, radiation or the presence and amount of a curing catalyst or accelerator and the like. The term refers both to complete and partial curing of the material.

“Radiation-curable” or “radiation cross-linkable” thus refers to compounds which chemically react and form new bonds (intra- or intermolecular) when exposed to radiation.

“Radiation”, as used herein, refers to electromagnetic radiation, in particular UV light and visible light, as well as electron beams. The curing preferably takes place by exposure to light, for example UV light or visible light.

The term “divalent”, as used herein in connection with groups, refers to a group having at least two bonding points which provide a connection to further molecule parts. In the context of the present invention, a divalent alkyl group therefore means a group of formula -alkyl-. A divalent alkyl group of this kind is also referred to herein as an alkylenyl group. Accordingly, “polyvalent” means that a group has more than one bonding point. For example, a group of this kind can also be trivalent, tetravalent, pentavalent or hexavalent. “At least divalent” therefore means divalent or a higher valency.

The term “poly-” refers to a repeating unit of a (functional) group or structural unit following this prefix. A polyol thus refers to a compound having at least two hydroxy groups, and a polyalkylene glycol refers to a polymer consisting of alkylene glycol monomer units.

“Polyisocyanate”, as used herein, refers to organic compounds containing more than one isocyanate group (—NCO).

Unless indicated otherwise, the molecular weights indicated in the present text refer to the number average of the molecular weight (Mₙ). The number-average molecular weight can be determined on the basis of an end group analysis (OH number according to DIN 53240; NCO content as determined by titration according to Spiegelberger as per EN ISO 11909) or by means of gel permeation chromatography according to DIN 55672-1:2007-08 with THF as the eluent. Unless stated otherwise, all specified molecular weights are those which have been determined by means of end group analysis.

Alkenyl ethers can be aliphatic compounds containing, in addition to the alkenyl ether group(s), at least one other functional group that reacts with epoxy or cyclic carbonate groups, including —OH, —COOH, —SH, —NH₂ and derivatives thereof. The functional groups engage in a nucleophilic manner with the ring carbon of the epoxide ring or with the carbonyl-carbon atom of the cyclic carbonate, the ring opening and resulting in a hydroxyl group. Depending on the reactive, nucleophilic group, an O—C—, N—C, S—C, or O—/N—/S—C(═O)O bond is formed in the process.

The alkenyl ether polyol can be produced for example using two alternative routes A) and B).

In the case of route A), an alkenyl ether, containing at least one alkenyl ether group and at least one functional group selected from —OH, —COOH, —SH, —NH₂ and derivatives thereof, is reacted with (i) an epoxide or (ii) a cyclic carbonate or derivative thereof.

In the case of route B, an alkenyl ether, containing at least one alkenyl ether group and at least one functional group selected from (i) epoxide groups and (ii) cyclic carbonate groups or derivatives thereof is reacted with an alcohol, thiol, a carboxylic acid, or an amine or derivatives thereof.

Irrespective of the route, the alkenyl ether polyols result from reacting the hydroxy, thiol, carboxylic or amino groups with an epoxide or cyclic carbonate group on account of ring opening.

In all the embodiments, the reaction partners are selected such that the reaction product, i.e. the alkenyl ether polyol obtained, bears at least two hydroxyl groups.

For example, the alkenyl ether polyol can be produced by reacting an alkenyl ether, containing at least one alkenyl ether group and at least one functional group selected from —OH, —COOH, —SH, —NH₂ and derivatives thereof, with (i) an epoxide or (ii) a cyclic carbonate or derivative thereof, the alkenyl ether polyol produced in this way being an alkenyl ether polyol of formula (I)

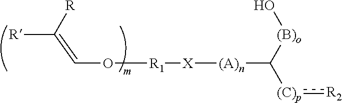

In the compounds of formula (I),
R₁ is an at least divalent organic group, optionally having 1 to 1000 carbon atoms, in particular an at least divalent linear or branched, substituted or unsubstituted alkyl having 1 to 50, preferably 1 to 20 carbon atoms, or an at least divalent linear or branched, substituted or unsubstituted heteroalkyl having 1 to 50, preferably 1 to 20 carbon atoms and at least one oxygen or nitrogen atom,
R₂ is an organic group, optionally having an —OH group and/or 1 to 1000 carbon atoms, in particular an (optionally divalent or polyvalent) linear or branched, substituted or unsubstituted alkyl having 1 to 50, preferably 1 to 20 carbon atoms, or an (optionally divalent or polyvalent) linear or branched, substituted or unsubstituted heteroalkyl having 1 to 50, preferably 1 to 20 carbon atoms and at least one oxygen or nitrogen atom. R₂ may however also be a high-molecular group, for example a polyalkylene glycol group. Such a (poly)alkylene glycol group may for example have formula —O—[CHRₐCH₂O]_{b}—R_{b}, where Rₐ is H or a C₁₋₄ alkyl group, R_{b} is —H or an organic group and b is 1 to 100.

In the compounds of formula (I), X is O, S, C(═O)O, OC(═O)O, C(═O)OC(═O)O, NRₓ, NRₓC(═O)O, NRₓC(═O)NRₓ or OC(═O)NRₓ. In preferred embodiments, X is O, OC(═O)O, NRₓ or NRₓC(═O)O.

Each R and R′ is independently selected from H, C₁₋₂₀ alkyl and C₂₋₂₀ alkenyl, where in particular one of R and R′ is H and the other is C₁₋₄ alkyl or both R and R′ are H, particularly preferably, R is hydrogen (H) and R′ is H or —CH₃.

Each A, B, and C is independently selected from CR″R′″, where R″ and R′″ are independently selected from H, a functional group, such as —OH, —NH₂, —NO₂, —CN, —OCN, —SCN, —NCO, —NCS, —SH, —SO₃H or —SO₂H, and an organic group. In particular, R″ and R′″ are, independently, H or C₁₋₂₀ alkyl. R″ and R′″ can however also form an organic group, including cyclic groups, or a functional group, jointly or together with the carbon atom to which they are bonded. Examples of groups of this kind are ═CH₂, ═CH-alkyl or ═C(alkyl)₂, ═O, ═S, —(CH₂)ₐₐ—, where aa=3 to 5, or derivatives thereof, in which one or more methylene groups are replaced by heteroatoms such as N, O or S. Two of R″ and R′″, which are bonded to adjacent carbon atoms, may also form a bond together, however. This results in a double bond (i.e. —C(R″)═C(R′″)—) being formed between the two adjacent carbon atoms.
[symbol] represents a single or double bond. If it represents a double bond, the carbon atom that is bonded to R₂ bears only one substituent R′ or R′″.

In the compounds of formula (I), m is an integer of from 1 to 10, preferably 1 or 2, particularly preferably 1. This means the compounds preferably bear only one or two alkenyl ether groups.
n, p and o are each 0 or an integer of from 1 to 10. In this way, they meet the condition whereby n+p+o=1 or more, in particular 1 or 2. It is particularly preferable for n or o to be 1 and for the other to be 0. Alternatively, it is particularly preferable for n or o to be 2 and for the other to be 0. It is further preferred for p to be 0 and for one of n and o to be 1 or 2 and for the other to be 0. Embodiments in which n and o are 1 and p is 0 are also preferred.
   Rₓ is H, an organic group or

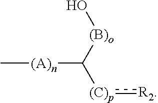

In order for the alkenyl ether polyol to have at least two hydroxyl groups, the compound of

formula (I) further meets the condition whereby Rₓ is not

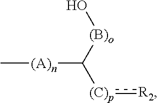

R₂ has at least one substituent that is selected from —OH and

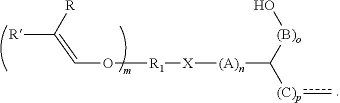

The second hydroxyl group of the compound of formula (I) is therefore either contained as a substituent in the organic group R₂ or X contains a further group of formula

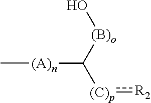

In various embodiments of the described production method, which embodiments show an alkenyl ether polyol, the alkenyl ether, which contains at least one alkenyl ether group and at least one functional group selected from —OH, —COOH, —SH, —NH₂ and derivatives thereof, is an alkenyl ether of formula (II).

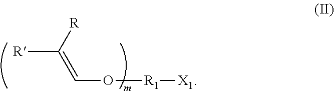

An alkenyl ether of this kind may be used, for example, in order to synthesize an alkenyl ether polyol of formula (I) by being reacted with an epoxide or a cyclic carbonate.

In the compounds of formula (II), R₁, R, R′ and m are as defined above for formula (I). In particular, the preferred embodiments of R₁, R, R′ and m described above for the compounds of formula (I) can likewise be transferred to the compounds of formula (II).

In the compounds of formula (II),
X₁ is a functional group selected from —OH, —COOH, —SH, —NHR_{y} and derivatives thereof, and
R_{y} is H or an organic group, preferably H.

The derivatives of the functional groups —OH, —COOH, —SH, —NHR_{y} are preferably the ionic variants already described above in connection with the definition of the term, which variants result from removing or bonding a proton, in this case in particular the alcoholates, thiolates and carboxylates, most particularly preferably the alcoholates.
X₁ is particularly preferably —OH or —O⁻ or —NH₂.

One embodiment of the described method for producing the alkenyl ether polyols is further characterized in that, in the alkenyl ether of formula (II), m is 1, X₁ is —OH or —NH₂, preferably —OH, R₁ is a divalent, linear or branched C₁₋₁₀ alkyl group (alkylenyl group), in particular ethylenyl, propylenyl, butylenyl, pentylenyl or hexylenyl, and one of R and R′ is H and the other is H or —CH₃.

The alkenyl ethers which can be used as part of the described method for producing the alkenyl ether polyols, in particular those of formula (II), may be e.g. reaction products of various optionally substituted alkanols (monoalcohols and polyols) with acetylene. Specific examples include, without being limited thereto, 4-hydroxybutyl vinyl ether (HBVE) and 3-amino propyl vinyl either (APVE).

A further embodiment of the described method for producing the alkenyl ether polyols is characterized in that the epoxide reacted with the alkenyl ether is an epoxide of formula (III) or (IIIa)

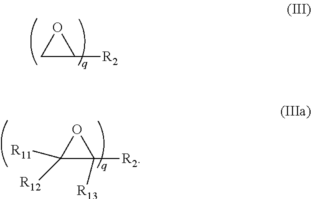

In compounds of formula (III) and (IIIa), R₂ is as defined above for formula (I).
R₁₁, R₁₂ and R₁₃ are, independently of one another, H or an organic group, optionally having at least one —OH group, in particular a linear or branched, substituted or unsubstituted alkyl having 1 to 20 carbon atoms, or a linear or branched, substituted or unsubstituted heteroalkyl having 1 to 20 carbon atoms and at least one oxygen or nitrogen atom.
q is an integer of from 1 to 10, preferably 1 or 2.

Epoxy compounds which can be used in the method for producing alkenyl ether polyols are therefore preferably linear or branched, substituted or unsubstituted alkanes having a carbon atom number of from 1 to 1000, preferably 1 to 50 or 1 to 20, bearing at least one epoxy group. Optionally, said epoxy compounds can additionally bear another one or more hydroxy groups, as a result of which the degree of hydroxyl functionalization of the alkenyl ether polyol resulting from the reaction with an epoxide of an alkenyl ether that is reactive to epoxides, as described above, is high. This leads, in turn, to the cross-link density of the desired polymer being controllable in later polymerization reactions.

In the case of a reaction of an alkenyl ether compound that is reactive to epoxides (alkenyl ether having at least one functional group selected from —OH, —COOH, —SH, —NH₂ and derivatives thereof), an alcohol results on account of ring opening of the epoxide. As a result of the reaction of a first alcohol or, in this context, a chemically related compound (amine, thiol, carboxylic acid, etc.) with an epoxide, the alcoholic group is thus “regenerated” in the course of the bond formation.

In various embodiments, the epoxy compound can bear more than one epoxy group. This makes it possible to react an epoxy compound of this kind with more than one alkenyl ether compound that is reactive to epoxides, for example an aminoalkenyl ether or a hydroxy alkenyl ether.

In particularly preferred embodiments, the epoxide is an epoxide of formula (III), where q is 1 or 2, and if q is 2, R₂ is —CH₂—O—C₁₋₁₀-alkylenyl-O—CH₂—, and if q is 1, R₂ is —CH₂—O—C₁₋₁₀-alkyl.

Examples of epoxy compounds that can be used in the methods for producing the alkenyl ether polyols are in particular glycidyl ethers, such as, without limitation, 1,4-butanediol diglycidyl ether (BDDGE) and isopropyl glycidyl ether (IPGE).

In various embodiments, the alkenyl ether polyol of formula (I) can be obtained by reacting an alkenyl ether of formula (II) with an epoxide of formula (III) or (IIIa).

Rather than an epoxide, the compounds that are reacted with the compounds reactive to epoxides (alkenyl ether compounds) may also be cyclic carbonates or derivatives thereof. Cyclic carbonate compounds exhibit a reactivity that is similar in nature to the epoxides in respect of compounds used as the reaction partners, which compounds add, in a nucleophilic manner, both epoxides and cyclic carbonate compounds by means of ring opening and “regeneration” of an alcoholic functional group to, in the case of an epoxide, the methylene of the epoxide ring or, in the case of a cyclic carbonate, the carbonyl carbon atom, as a result of which an O—C—, N—C, S—C, or O—/N—/S—C(═O)O bond is formed depending on the reactive, nucleophilic group.

The cyclic carbonates, which in the described method for producing the alkenyl ether polyols can be reacted with an alkenyl ether, in particular an alkenyl ether of formula (II), are, in preferred embodiments, ethylene carbonates of formula (IV) or (IVa).

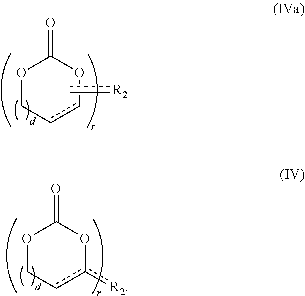

In compounds of formula (IV) and (IVa), R₂ is as defined above for formula (I), (III) and (IIIa). In particular, R₂ is a C₁₋₁₀ hydroxyalkyl. In further embodiments, R₂ may be ═CH₂.

[symbol] represents a single or double bond, preferably a single bond. It goes without saying that, if the ring contains a double bond, R₂ is not bonded by an exo double bond but by a single bond, and vice versa.
d is 0, 1, 2, 3, 4 or 5, preferably 0 or 1, particularly preferably 0, and r is an integer of from 1 to 10, preferably 1 or 2, most particularly preferably 1.

If d is 1, i.e. the cyclic carbonate is a 1,3-dioxan-2-one, R₂ can be in the fourth or fifth position, but preferably in the fifth position.

Examples of cyclic carbonates include, without being limited thereto, 1,3-dioxolan-2-one, 4,5-dehydro-1,3-dioxolan-2-one, 4-methylene-1,3-dioxolan-2-one, and 1,3-dioxan-2-one, which are substituted in the fourth or fifth position by R₂.

In various embodiments of the described methods for producing the alkenyl ether polyols, cyclic carbonates are used which are derivatives of the carbonates of formulas (IV) and (IVa). Examples of derivatives include those which are substituted on the ring methylene groups, in particular those that do not bear the R₂ group, for example by organic groups, in particular linear or branched, substituted or unsubstituted alkyl or alkenyl groups having up to 20 carbon atoms, in particular ═CH₂ and —CH═CH₂, or linear or branched, substituted or unsubstituted heteroalkyl or heteroalkenyl groups having up to 20 carbon atoms and at least one oxygen or nitrogen atom, or functional groups such as —OH or —COOH. Examples of such derivatives include for example 4-methylene-1,3-dioxolan-2-one, which bears the R₂ group at the fifth position, or di-(trimethylolpropane) dicarbonate, where the R₂ group in the fifth position is a methylene-trimethylol monocarbonate group.

In various embodiments in which the R₂ group is bonded by means of a single bond, the ring carbon atom bearing the R₂ group can be replaced by another substituent, which is defined in the same way as the above-mentioned substituents for the other ring methylene group.

Further derivatives are those in which one or both of the ring oxygen atoms are replaced by sulfur atoms, and those in which, alternatively or in addition, the carbonyl oxygen atom is replaced by a sulfur atom. A particularly preferred derivative is 1,3-oxathiolane-2-thione.

In various embodiments, the cyclic carbonate is 4-methylene-1,3-dioxolan-2-one, which bears the R₂ group at the fifth position. If a cyclic carbonate of this kind is reacted with an alkyl ether bearing an amino group as the reactive group, a compound of formula (Ia) can be formed:

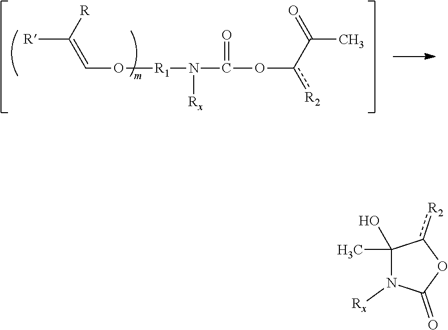

In this compound, m, R₁, R, R′, R₂ and Rₓ are as defined above for the compounds of formula (I)-(IV). Said compounds of formula (Ia) do not contain an alkenyl ether group and can therefore be used as polyols for producing polyurethanes, but only in combination with further polyols containing the alkenyl ether groups. Such compounds of formula (Ia) are therefore not preferred according to the invention.

When reacting the above-described cyclic carbonates and derivatives thereof of formula (IV) and (IVa) with a compound of formula (II), in various embodiments, in the compounds of formula (II), (i) X₁ is —NH₂ or a derivative thereof, and q or r is 1; or (ii) X₁ is —OH or a derivative thereof, and q or r is 2.

In further embodiments, the alkenyl ether polyol can be obtained by reacting the compounds specified in route B). Here, the alkenyl ether polyol is produced by reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof.

In various embodiments of this method, the alkenyl ether polyol is an alkenyl ether polyol of formula (V).

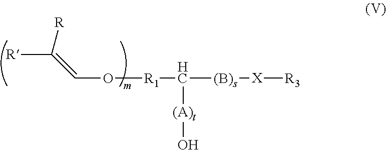

In the compounds of formula (V), R₁ is as defined above for the compounds of formula (I).
R₃ is an organic group, optionally having at least one —OH group and/or 1 to 1000 carbon atoms, in particular an (optionally divalent or polyvalent) linear or branched, substituted or unsubstituted alkyl having 1 to 50, preferably 1 to 20 carbon atoms, or an (optionally divalent or polyvalent) linear or branched, substituted or unsubstituted heteroalkyl having 1 to 50, preferably 1 to 20 carbon atoms and at least one oxygen or nitrogen atom. R₂ may however also be a high-molecular group, for example a polyalkylene glycol group. Such a (poly)alkylene glycol group may for example have formula —O—[CHRₐCH₂O]_{b}—R_{b}, where Rₐ is H or a C₁₋₄ alkyl group, R_{b} is —H or an organic group or is

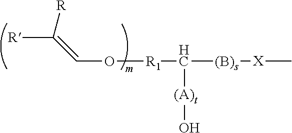

and b is 1 to 100.

In the compounds of formula (V), X is O, S, OC(═O), OC(═O)O, OC(═O)OC(═O), NR_{z}, NR_{z}C(═O)O, NR_{z}C(═O)NR_{z} or OC(═O)NR_{z}. In preferred embodiments, X is O, OC(═O)O, NR_{z} or OC(═O)NR_{z}.

Each R and R′ is independently selected from H, C₁₋₂₀ alkyl and C₂₋₂₀ alkenyl, where in particular one of R and R′ is H and the other is C₁₋₄ alkyl or both R and R′ are H. Particularly preferably, R is H and R′ is H or —CH₃.

Each A and B is independently selected from CR″R′″, where R″ and R′″ are independently selected from H, a functional group, such as —OH, —NH₂, —NO₂, —CN, —OCN, —SCN, —NCO, —NCS, —SH, —SO₃H or —SO₂H, and an organic group. In particular, R″ and R′″ are, independently, H or C₁₋₂₀ alkyl. R″ and R′″ can however also form an organic group, including cyclic groups, or a functional group, jointly or together with the carbon atom to which they are bonded. Examples of groups of this kind are ═CH₂, ═CH-alkyl or ═C(alkyl)₂, ═O, ═S, —(CH₂)ₐₐ—, where aa=3 to 5, or derivatives thereof, in which one or more methylene groups are replaced by heteroatoms such as N, O or S. Two of R″ and R′″, which are bonded to adjacent carbon atoms, may also form a bond together, however. This results in a double bond (i.e. —C(R″)═C(R′″)—) being formed between the two adjacent carbon atoms.

In the compounds of formula (V), m is an integer of from 1 to 10, preferably 1 or 2, particularly preferably 1. This means the compounds preferably bear only one or two alkenyl ether groups.
s and t are each 0 or an integer of from 1 to 10. In this way, they meet the condition whereby s+t=1 or more, in particular 1 or 2. It is particularly preferable for s or t to be 1 and for the other to be 0.

R_{z} is H, an organic group or

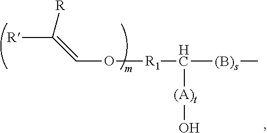

In order for the alkyl ether polyol of formula (V) to meet the condition whereby it bears at least two hydroxyl groups, when R_{z} is not

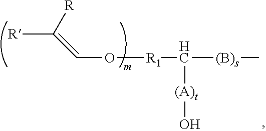

R₃ is substituted by at least one substituent that is selected from —OH and

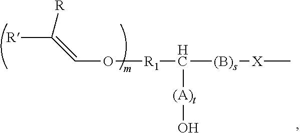

In preferred embodiments, the method is characterized in that the alkenyl ether, which contains at least one alkenyl ether group and at least one functional group selected from (i) epoxide groups and (ii) cyclic carbonate groups or derivatives thereof, is an alkenyl ether of formula (VI) or (VII)

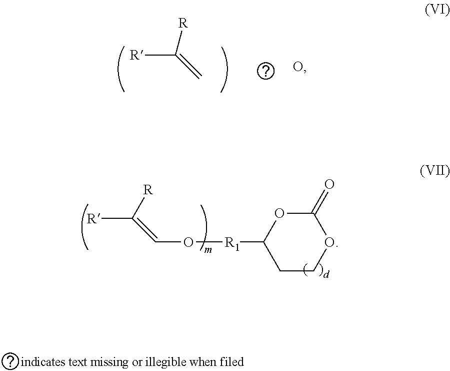

In the compounds of formula (VI) or (VII) , R₁, R, R′ and m are as defined above for the compounds of formulas (I) and (II).
d is as defined above for formulas (IV) and (IVa), i.e. d is 0, 1, 2, 3, 4 or 5, preferably 0 or 1, particularly preferably 0.

In particularly preferred embodiments, R₁ is —C₁₋₁₀-alkylenyl-O—CH₂— in the alkenyl ethers of formula (VI) or (VII).

The alkenyl ethers of formula (VI) bearing epoxy groups may be substituted at the epoxy group, i.e. the methylene groups of the oxirane ring may, as shown in formula (IIIa), be substituted by R₁₁-R₁₃.

In various embodiments, the alkenyl ethers of formula (VII) are substituted at the cyclic carbonate ring, or the cyclic carbonate ring is replaced by an appropriate derivative. Suitable substituted cyclic carbonates and derivatives thereof are those which have been described above in connection with formula (IV) and (IVa). In particular, the cyclic carbonate group is preferably a 1,3-dioxolan-2-one or 1,3-dioxan-2-one group, which can optionally be substituted, for example by a methylene group.

Suitable compounds of formula (VI) include, without being limited thereto, vinyl glycidyl ether and 4-glycidyl butyl vinyl ether (GBVE), with the latter being obtainable by reacting 4-Hydroxybutyl vinyl ether with epichlorohydrin.

Suitable compounds of formula (VII) include, without being limited thereto, 4-(ethenyloxymethyl)-1,3-dioxolan-2-one, which can be obtained for example by transesterification of glycerol carbonate with ethyl vinyl ether, or 4-glycerolcarbonate(4-butylvinylether)ether (GCBVE), which can be obtained by epoxidation of hydroxybutyl vinyl ether (HBVE) and subsequent CO₂ insertion.

In various embodiments, the alkenyl ether, which contains at least one alkenyl ether group and at least one functional group selected from (i) epoxide groups and (ii) cyclic carbonate groups or derivatives thereof, in particular an alkenyl ether of one of formula (VI) or (VII), is reacted with an alcohol. The alcohol may be a diol or polyol or an appropriate alcoholate. In particular, the alcohol may be a polyalkylene glycol of formula HO—[CHRₐCH₂O]_{b}—H, where Rₐ is H or a C₁₋₄ alkyl group and b is 1 to 100, in particular 1 to 10.

Route B) therefore constitutes an alternative embodiment in which the epoxide compounds or the cyclic carbonate compounds (for example ethylene carbonate or trimethylene carbonate compounds) have at least one or more alkenyl ether groups. The reaction of said epoxide compounds or cyclic carbonate compounds with compounds that are reactive to epoxides or to compounds (cyclic carbonates) reacting in a chemically similar manner in the context of this invention, in particular those bearing —OH, —COOH, —SH, —NH₂ and similar groups or derivatives thereof, for example appropriately functionalized, preferably appropriately polyfunctionalized linear or branched, saturated or partially unsaturated, additionally substituted or unsubstituted, cyclic or linear (hetero)alkyls and (hetero)aryls, results in the desired alkenyl ether polyols.

Examples of compounds having at least one of the groups —OH, —COOH, —SH, —NH₂ and forms derived therefrom, but having no alkenyl ether groups, are for example, without limitation, glycols, polyglycols, polyols, amino acids and amines, such as glycine, glycerol, hexamethylenediamine, 1,4-butanediol and 1,6-hexanediol.

The alkenyl ether polyols which can be produced or obtained by means of the described methods are for example compounds of formulas (I), (Ia) and (V), as defined above.

In various embodiments of the alkenyl ether polyols of formula (I):

(1) m=1; R and R′ are H or R is H and R′ is methyl; R₁ is C₁₋₁₀ alkylenyl, in particular C₁₋₆ alkylenyl, X is O, A and B are CH₂, n and o are 1 or 0 and p is 0, where n+o=1, and R₂ is an organic group that is substituted by —OH or bears a further group of formula

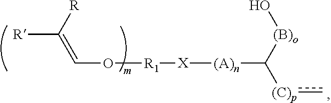

where R₁, m, R, R′, A, B, C, n, o and p are as defined above;
or
(2) m=1; R and R′ are H or R is H and R′ is methyl; R₁ is C₁₋₁₀ alkylenyl, in particular C₁₋₆ alkylenyl, X is NRₓ, A and B are CH₂, n and o are 1 or 0 and p is 0, where n+o=1, Rₓ is H or

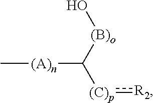

where A, B, C, n, o and p are as defined above; and R₂ is an organic group as defined above which, if R_{X} is H, is substituted by —OH or bears a further group of formula

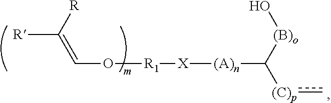

where R₁, m, R, R′, A, B, C, n, o and p are as defined above; or
(3) m=1; R and R′ are H or R is H and R′ is methyl; R₁ is C₁₋₁₀ alkylenyl, in particular C₁₋₆ alkylenyl, X is OC(═O)O, A and B are CH₂, n and o are 1 or 0 and p is 0, where n+o=1, and R₂ is an organic group that is substituted by —OH or bears a further group of formula

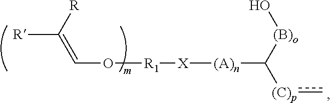

where R₁, m, R, R′, A, B, C, n, o and p are as defined above; or
(4) m=1; R and R′ are H or R is H and R′ is methyl; R₁ is C₁₋₁₀ alkylenyl, in particular C₁₋₆ alkylenyl, X is NRₓC(═O)O, A and B are CH₂, n and o are 1 or 0 and p is 0, where n+o=1, Rₓ is H or

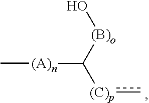

where A, B, C, n, o and p are as defined above; and R₂ is an organic group as defined above which, if R_{X} is H, is substituted by —OH or bears a further group of formula

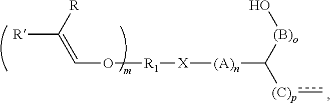

where R₁, m, R, R′, A, B, C, n, o and p are as defined above.

In the above-mentioned embodiments, R₂ is preferably bonded by means of a single bond and may for example be a heteroalkyl group, in particular an alkyl ether group having 2 to 10 carbon atoms. For example groups of formula —CH₂—O—(CH₂)₄—O—CH₂— (if R₂ bears two alkenyl ether groups of the above formula) or —CH₂—O—CH(CH₃)₂ are suitable.

In various embodiments of the alkenyl ether polyols of formula (V):

(1) m=1; R and R′ are H or R is H and R′ is methyl; R₁ is —(CH₂)₁₋₁₀—O—CH₂—, in particular —(CH₂)₁₋₆—O—CH₂—, X is O, A and B are CH_{2,}, s and t are 1 or 0, where s+t=1, and R₃ is an organic group that is substituted by —OH or bears a further group of formula

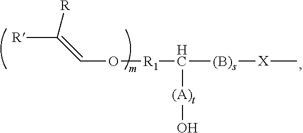

where R₁, m, R, R′, A, B, s, and t are as defined above; or
(2) m=1; R and R′ are H or R is H and R′ is methyl; R₁ is —(CH₂)₁₋₁₀—O—CH₂—, in particular —(CH₂)₁₋₆—O—CH₂—, X is NR_{z}, A and B are CH_{2,}, s and t are 1 or 0, where s+t=1, R_{z} is H or

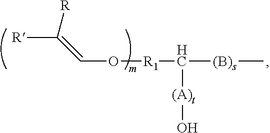

where A, B, m, s and t are as defined above; and R₃ is an organic group as defined above which, if R_{z} is H, is substituted by —OH or bears a further group of formula

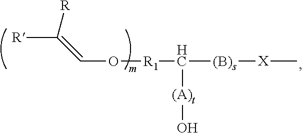

where R₁, m, R, R′, A, B, s, and t are as defined above; or
(3) m=1; R and R′ are H or R is H and R′ is methyl; R₁ is —(CH₂)₁₋₁₀—O—CH₂—, in particular —(CH₂)₁₋₆—O—CH₂—, X is OC(═O)O, A and B are CH_{2,}, s and t are 1 or 0, where s+t=1, and R₃ is an organic group that is substituted by —OH or bears a further group of formula

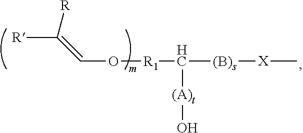

where R₁, m, R, R′, A, B, s, and t are as defined above; or
(4) m=1; R and R′ are H or R is H and R′ is methyl; R₁ is —(CH₂)₁₋₁₀—O—CH₂—, in particular —(CH₂)₁₋₆—O—CH₂—, X is OC(═O)NR_{z}—, A and B are CH_{2,}, s and t are 1 or 0, where s+t=1, R_{z} is H or

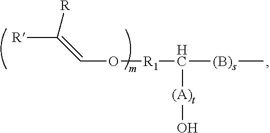

where A, B, m, s and t are as defined above; and R₃ is an organic group as defined above which, if R_{z} is H, is substituted by —OH or bears a further group of formula

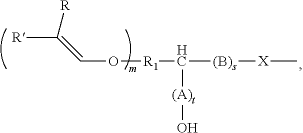

where R₁, m, R, R′, A, B, s, and t are as defined above.

In the above-mentioned embodiments of the compounds of formula (V), R₃ is for example a heteroalkyl group, in particular a (poly)alkylene glycol, such as in particular polypropylene glycol, or a C₁₋₁₀ alkyl or alkylenyl group.

The individual steps of the described method for producing the alkenyl ether polyols of formula (I) or (V) can be carried out according to the methods that are conventional for reactions of this kind. For this purpose, the reaction partners are brought into contact with one another optionally following activation (for example production of alcoholates by reaction with sodium), and reacted, optionally in a protective gas atmosphere and subject to temperature controls.

The alkenyl ether polyols produced in this manner are precursors to the subsequent synthesis of radiation-curable polyurethanes by reaction with a polyisocyanate. The alkenyl ether polyols, in particular the vinyl ether polyols, which are described herein, may for example be used in addition or as alternatives to known polyols for the synthesis of polyurethanes. Known polyols that are used for PU synthesis include for example polyether and polyester polyols, but are not, however, limited thereto. For the polyurethane synthesis, the polyols or mixtures of polyols containing the described alkenyl ether polyols are reacted in molar excess with polyisocyanates. In this case, the reaction takes place under conditions that are known per se, i.e. at an elevated temperature and optionally in the presence of a catalyst. Depending on the amount of alkenyl ether polyol used, the polyurethane (pre)polymers obtained have the desired density of cross-linkable alkenyl ether groups.

In various embodiments, therefore, in addition to the at least one alkenyl ether polyol, at least one further polyol is used that is not functionalized with alkenyl ether groups. In this case, all polyols known for PU synthesis are suitable, for example monomer polyols, polyester polyols, polyether polyols, polyester-ether polyols, polycarbonate polyols, hydroxy-functional polysiloxanes, in particular polydimethylsiloxanes, such as Tegomer® H—Si 2315 (Evonik, DE) or mixtures of two or more thereof.

Polyether polyols may be produced from a plurality of alcohols containing one or more primary or secondary alcohol groups. As an initiator for the production of polyethers that do not contain any tertiary amino groups, the following compounds or mixtures of said compounds can be used by way of example: Water, ethylene glycol, propylene glycol, glycerol, butanediol, butanetriol, trimethylolethane, pentaerythritol, hexanediol, 3-hydroxyphenol, hexanetriol, trimethyloipropane, octanediol, neopentyl glycol, 1,4-hydroxymethylcyclohexane, bis(4-hydroxyphenyl)dimethylmethane and sorbitol. Ethylene glycol, propylene glycol, glycerol and trimethyloipropane are preferably used, particularly preferably ethylene glycol and propylene glycol, and, in a particularly preferred embodiment, propylene glycol is used.

Alkylene oxides such as ethylene oxide, propylene oxide, butylene oxide, epichlorohydrin, styrene oxide or tetrahydrofuran or mixtures of these alkylene oxides may be used as cyclic ethers for producing the above-described polyethers. Propylene oxide, ethylene oxide or tetrahydrofuran or mixtures thereof are preferably used. Propylene oxide or ethylene oxide or mixtures thereof are particularly preferably used. Propylene oxide is most particularly preferably used.

Polyester polyols can be produced for example by reacting low-molecular-weight alcohols, in particular ethylene glycol, diethylene glycol, neopentyl glycol, hexanediol, butanediol, propylene glycol, glycerol, or trimethylolpropane with caprolactone. 1,4-hydroxymethylcyclohexane, 2-methyl-1,3-propanediol, 1,2,4-butanetriol, triethylene glycol, tetraethylene glycol, polyethylene glycol, dipropylene glycol, polypropylene glycol, dibutylene glycol and polybutylene glycol are also suitable as polyfunctional alcohols for producing polyester polyols.

Further suitable polyester polyols may be produced by polycondensation. Difunctional and/or trifunctional alcohols having an insufficient amount of dicarboxylic acids or tricarboxylic acids or mixtures of dicarboxylic acids or tricarboxylic acids, or reactive derivatives thereof, may thus be condensed to form polyester polyols. Suitable dicarboxylic acids are, for example, adipic acid or succinic acid and higher homologs thereof having up to 16 carbon atoms, also unsaturated dicarboxylic acids such as maleic acid or fumaric acid and aromatic dicarboxylic acids, in particular isomeric phthalic acids, such as phthalic acid, isophthalic acid or terephthalic acid. Suitable tricarboxylic acids are for example citric acid or trimellitic acid. The aforementioned acids can be used individually or as mixtures of two or more thereof. Particularly suitable alcohols are hexanediol, butanediol, ethylene glycol, diethylene glycol, neopentyl glycol, 3-hydroxy-2,2-dimethylpropyl-3-hydroxy-2,2-dimethylpropanoate or trimethylolpropane or mixtures of two or more thereof. Particularly suitable acids are phthalic acid, isophthalic acid, terephthalic acid, adipic acid or dodecanedioic acid, or mixtures thereof. Polyester polyols having a high molecular weight include for example the reaction products of polyfunctional, preferably difunctional alcohols (optionally together with small quantities of trifunctional alcohols) and polyfunctional, preferably difunctional carboxylic acids. Instead of free polycarboxylic acids, the corresponding polycarboxylic acid anhydrides or corresponding polycarboxylic acid esters can also be used (where possible) with alcohols having preferably 1 to 3 carbon atoms. The polycarboxylic acids can be aliphatic, cycloaliphatic, aromatic or heterocyclic, or both. They can optionally be substituted, for example by alkyl groups, alkenyl groups, ether groups or halogens. Suitable polycarboxylic acids are, for example, succinic acid, adipic acid, suberic acid, azelaic acid, sebacic acid, dodecanedioic acid, phthalic acid, isophthalic acid, terephthalic acid, trimellitic acid, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimer fatty acid or trimer fatty acid, or mixtures of two or more thereof.

Polyesters that can be obtained from lactones, for example based on ε-caprolactone, also referred to as “polycaprolactone”, or hydroxycarboxylic acids, for example ω-hydroxy caproic acid, can also be used.

However, polyester polyols of oleochemical origin can also be used. Polyester polyols of this kind can be produced, for example, by complete ring opening of epoxidized triglycerides of a fat mixture which contains an at least partially olefinically unsaturated fatty acid having one or more alcohols having 1 to 12 C atoms and subsequent partial transesterification of the triglyceride derivatives to form alkyl ester polyols having 1 to 12 C atoms in the alkyl group.

Polycarbonate polyols can be obtained, for example, by reacting diols such as propylene glycol, butanediol-1,4 or hexanediol-1,6, diethylene glycol, triethylene glycol or tetraethylene glycol or mixtures of said diols with diaryl carbonates, for example diphenyl carbonates, or phosgene.

Suitable polyisocyanates are aliphatic, aromatic and/or alicyclic isocyanates having two or more, preferably two to at most approximately four isocyanate groups. Particularly preferably, monomeric polyisocyanates, in particular monomeric diisocyanates, are used in the context of the present invention. Examples of suitable monomeric polyisocyanates are: 1,5-naphthylene diisocyanate, 2,2′-, 2,4′- and/or 4,4′-diphenylmethane diisocyanate (MDI), hydrogenated MDI (H12MDI), allophanates of the MDI, xylylene diisocyanate (XDI), tetramethylxylylene diisocyanate (TMXDI), 4,4′-diphenyl dimethylmethane diisocyanate, di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanato phenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanato-ethyl ester, also diisocyanates having reactive halogen atoms, such as 1-chloromethylphenyl-2,4-diisocyanate, 1-bromomethylphenyl-2,6-diisocyanate, 3,3-bis-chlormethylether-4,4′-diphenyl diisocyanate or sulfur-containing polyisocyanates. Sulfur-containing polyisocyanates can be obtained for example by reacting 2 mol hexamethylene diisocyanate with 1 mol thiodiglycol or dihydroxydihexyl sulfide.

Further diisocyanates which can be used are for example trimethylhexamethylene diisocyanate, 1,4-diisocyanatobutane, 1,12-diisocyanatododecane and dimer fatty acid diisocyanate. The following are particularly suitable: Tetramethylene, hexamethylene, undecane, dodecamethylene, 2,2,4-trimethylhexane, 2,3,3-trimethylhexamethylene, 1,3-cyclohexane, 1,4-cyclohexane, 1,3- or 1,4-tetramethylxylene, isophorone, 4,4-dicyclohexylmethane and lysine ester diisocyanate.

Suitable at least trifunctional isocyanates are polyisocyanates which are obtained by trimerization or oligomerization of diisocyanates or by reacting diisocyanates with polyfunctional compounds containing hydroxyl or amino groups.

The diisocyanates already disclosed above are isocyanates suitable for producing trimers, the trimerization products of the isocyanates HDI, MDI, TDI or IPDI being particularly preferred.

Furthermore, adducts of diisocyanates and low-molecular-weight triols are suitable as triisocyanates, in particular the adducts of aromatic diisocyanates and triols, such as trimethylolpropane or glycerol. The polymeric isocyanates, as occur for example as a residue in the distillation bottom when distilling diisocyanates, are also suitable for being used. Polymeric MDI, as can be obtained from the distillation residue when distilling MDI, is particularly suitable in this case.

The stoichiometric excess of polyisocyanate when synthesizing the polyurethanes is, based on the molar ratio of NCO to OH groups, in particular 1:1 to 1.8:1, preferably 1:1 to 1.6:1 and particularly preferably 1.05:1 to 1.5:1.

The corresponding polyurethanes typically have an NCO content of from 5-20 wt. %, preferably 9 to 19, more preferably 13-18, most preferably 12-17 wt. %, and have a nominal average NCO functionality of from 2 to 3, preferably 2 to 2.7, more preferably 2 to 2.4, most preferably 2 to 2.1.

The molecular weight (Mn) of the polyurethanes is usually in the range of from 1,500 g/mol to 100,000 g/mol, particularly preferably 2,000 g/mol to 50,000 g/mol.

The production of the NCO-terminated polyurethanes is known per se to a person skilled in the art and takes place for example such that the polyols that are liquid at reaction temperatures are mixed with an excess of the polyisocyanates, and the resulting mixture is stirred until a constant NCO value is obtained. Temperatures in the range of from 40° C. to 180° C., preferably 50 to 140° C., are selected as the reaction temperature.

The possibility of combining the alkenyl ether polyols with other polyols allows a controlled synthesis of polymers with a fixed proportion of radiation-curable alkenyl ether groups to take place.

The NCO-terminated polyurethanes obtained in this manner and having alkenyl ether group-containing side chains can already be used as such for the two-stage curing process consisting of cationic cross-linking of the alkenyl ether groups and moisture-dependent polycondensation of the NCO groups.

However, in various embodiments they are end-group-capped with silanes in a further step. For this purpose, the NCO-terminated polyurethanes are reacted with a silane that additionally contains an NCO-reactive group, such as an amino or hydroxyl group. The silane can be a silane of formula X—[(CH₂)ₚ—Si(R¹)_{3-q}(OR²)_{q}]ᵣ, where p, q and r each independently represent an integer of from 1 to 3, each R¹ independently represents C₁₋₄ alkyl or —(CH₂)ₚ—Si(R¹)_{3-q}(OR²)_{q} and each R² independently represents C₁₋₄ alkyl, preferably methyl or ethyl. Here, X represents an NCO-reactive group, such as an amino, hydroxyl, carboxylic or thiol group, with amino and hydroxyl groups, in particular amino groups, being particularly preferred. This results, for example by means of a urethane group (—N—C(O)—O, if X=hydroxyl)) or a urea group (—N—C(O)—N, if X=amino), in silane end groups that are coupled to the polyurethanes.

The end-group capping can take place stoichiometrically with a molar excess of silane with respect to NCO groups, or also only in part with a molar deficiency of silane with respect to NCO groups. The latter case results in polymers also having terminal NCO groups in addition to silane end groups.

The invention therefore relates, in various embodiments, to polyurethanes having alkenyl ether group-containing side chains and silane end groups. The silane groups are in this case in particular those of —[(CH₂)ₚ—Si(R¹)_{3-q}(OR²)_{q}]ᵣwhere p, q and r=1, 2 or 3, R¹=C₁₋₄ alkyl or —(CH₂)ₚ—Si(R¹)_{3-q}(OR²)_{q} and R²=C₁₋₄ alkyl. In this case, the polyurethanes can be obtained by reacting at least one alkenyl ether polyol containing at least one alkenyl ether group, in particular a 1-alkenyl ether group, and at least two hydroxyl groups (—OH) with at least one polyisocyanate containing at least two isocyanate groups (—NCO), wherein the polyisocyanate, with respect to the isocyanate groups, is used in molar excess relative to the hydroxyl groups in order to obtain an NCO-terminated polyurethane, and the subsequent reaction of the NCO-terminated polyurethane with a silane, in particular a silane of formula X—[(CH₂)ₚ—Si(R¹)_{3-q}(OR²)_{q}]ᵣ, where X is an NCO—reactive group, preferably an amino or hydroxyl group, in particular an amino group (—NH₂). The polyurethanes obtained in this manner have alkenyl ether side chains, preferably vinyl ether side chains, and are silane-terminated. Depending on the stoichiometry of the silane used for the end-group capping, the polyurethanes obtained in this manner can also comprise silane and NCO end groups, as described above.

In various embodiments of the invention, R¹ in the silane groups is selected such that the end group contains 1-10 silicon atoms, preferably 1-3 silicon atoms, more preferably 1-2 silicon atoms, most preferably only 1 silicon atom. In various embodiments, the reactive silanes do not contain any tertiary amino groups. It is further preferable for the silanes used for the end-group capping not to be used in excess with respect to the NCO groups.

This also includes compositions containing such polyurethanes, such as adhesives, sealants and coating compositions.

The radiation- and moisture-curable polyurethanes that can be obtained by means of the methods described herein and comprise either NCO end groups or silane end groups can, during application, be cross-linked by radiation (cured) by means of a cationic polymerization mechanism in a first step, the curing taking place within a short period of time, usually within a few seconds. In a second step, there is further curing by means of a moisture-dependent curing mechanism, the water molecules required for the reaction preferably coming from the ambient air moisture or also from deliberately humidified air. Alternatively, the water molecules can also be provided by contact with water, for example by dipping into water. This second curing step usually takes several hours, or even days. The two curing steps by means of two separate curing mechanisms cooperate synergistically and are in particular suitable for applications in which the moisture-dependent curing is insufficient, since the rapid curing by means of radiation makes it possible to provide rapid increases in viscosity for rapid initial gelling (tan δ is <1 in rheological oscillation measurements at 60° C., a deformation of 0.1%, a frequency of 10 Hz and an initial gap of 0.3 mm with an applied normal force of Fn=0 N) or solidification, high initial strength and optionally adhesive-free handling before curing. It is therefore possible to use materials having a low initial viscosity that can very rapidly be converted into highly viscous materials by radiation and are not prone to merging, thus making it possible to easily join parts together. Preferred starting viscosities for such systems (complex viscosity at 20° C.) are in the range of <100,000 mPas, preferably <10,000 mPas, particularly preferably <2,000 mPas, most preferably <200 mPas. The viscosities are in this case determined by means of rheological oscillation measurements at 60° C., a deformation of 0.1%, a frequency of 10 Hz and an initial gap of 0.3 mm with an applied normal force of Fn=0 N.

A further advantage is that the moisture-curing groups can also react with a range of substrates/boundary surfaces, such as glass or metal surfaces, resulting in an advantageous impact on the adhesion of adhesives, coatings and sealants.

The cationic curing mechanism is in addition not sensitive to oxygen and provides dark-cure properties, i.e. the polymerization continues automatically following initiation. The isocyanate functionality additionally provides reaction media that are free of nucleophilic molecules and water, and this overcomes the drawbacks resulting from the sensitivity of the cationic reaction mechanism to nucleophiles. This makes it possible for the alkenyl ether to be highly reactive and for the initiation process to be more efficient and less sensitive. Therefore, in various embodiments in which silane-capped polyurethanes are used/obtained, it can be advantageous to use the silanes in a deficient amount in order to obtain some of the NCO functionalities for this purpose.

The invention therefore also relates, in one aspect, to a method for cross-linking or curing an alkenyl ether group-containing polyurethane polymer having moisture-reactive end groups, wherein the moisture-reactive end groups are isocyanate groups (—NCO) or silane groups of formula —(CH₂)ₚ—Si(R¹)_{3-q}(OR²)_{q}, where p and q=1, 2 or 3 and R¹ and R²=C₁₋₄ alkyl, wherein the polyurethane can be obtained by reacting at least one alkenyl ether polyol containing at least one alkenyl ether group, in particular a 1-alkenyl ether group, and at least two hydroxyl groups (—OH) with at least one polyisocyanate containing at least two isocyanate groups (—NCO), wherein the polyisocyanate, with respect to the isocyanate groups, is used in molar excess relative to the hydroxyl groups in order to obtain an NCO-terminated polyurethane, and optionally the subsequent reaction of the NCO-terminated polyurethane with a silane of formula X—(CH₂)ₚ—Si(R¹)_{3-q}(OR²)_{q}, where X is an NCO-reactive group, wherein, in a first step, the alkenyl ether groups are cationically cross-linked by UV exposure and, in a second step, the moisture-reactive groups are polymerized in a moisture-dependent manner.

In general, all photoinitiators known in the art are suitable for the radiation-dependent curing reaction. Said photoinitiators can optionally also be used in combination with known sensitizers. An overview of suitable initiators, in particular iodonium- and sulfur-based compounds, particularly those having anions selected from hexafluorophosphate (PF₆⁻), tetrafluoroborate (BF₄⁻) and hexafluoroantimonate (SbF₆⁻) can be found for example in Sangermano et al. (Macromol. Mater. Eng. 2014, 299, 775-793).

Fields of application for the described polyurethanes are in particular adhesive, sealant and coating applications as well as additive manufacturing methods/techniques, e.g. 3D printing techniques. In this case, the polyurethanes can be used in the form of compositions which additionally contain one or more of the components of such compositions that are conventional in the art.

Finally, the invention also relates to products containing the polyurethanes described herein, including in the cured state, such as molded parts that are bonded, sealed or coated using corresponding adhesives or coatings.

The invention will be further demonstrated in the following on the basis of examples; these are not intended to be limiting.

### EXAMPLES

### Materials Used

4-hydroxybutyl vinyl ether (HBVE) (BASF, 99% stabilized with 0.01% KOH) was stored using molecular sieve 4 Å. Sodium (Merck, 99%) was washed in dry diethyl ether and cut into pieces. The oxidized surface was trimmed in a nitrogen atmosphere before use. 4,4′-dimethyl-diphenyliodonium hexafluorophosphate (Omnicat 440, IGM, 98%) was sieved. 1,4-butanediol diglycidyl ether (BDDGE, Sigma-Aldrich, 95%), polypropylene glycol (PPG) (Dow Chemical, Voranol 2000 L, 2000 g/mol), hexamethylene diisocyanate (HDI, Acros Organics, 99%) and dimethyltin dineodecanoate (Momentive, Fomrez catalyst UL-28) were used as obtained.

### Example 1

### Synthesis of the Vinyl Ether Polyol (VEOH)

139.51 g (1.2 mol) HBVE was provided in a 250-ml round-bottomed flask. A dropping funnel having pressure equalization was attached and 24.78 g (0.12 mol) BDDGE was provided therein. The entire apparatus was dried in a vacuum and flooded with nitrogen. 7.00 g (0.3 mol) sodium was added. BDDGE was slowly added after the sodium had completely dissolved. The temperature was controlled such that it did not exceed 50° C. After all the BDDGE had been added, there was stirring at 50° C. for 30 min. 50 ml water was added in order to hydrolyze the remaining alcoholate. The product was washed several times with a saturated sodium chloride solution and water, then concentrated in a vacuum in order to remove any educt and water residues. Yield: 76%. ¹H-NMR (CDCl₃), xy MHz): δ (pp)=1.6-1.8 (12 H, mid-CH₂ butyl), 2.69 (2 H, OH, H/D replaceable), 3.4-3.55 (16 H, CH₂—O—CH₂), 3.70 (4 H, CH₂—O-vinyl), 3.94 (2 H, CH—O), 3.98 (1 H, CH₂═CH—O trans), 4.17 (1 H, CH₂═CH—O cis), 6.46 (1 H, CH₂═CH—O mixed).

### Example 2

### Synthesis of Vinyl-Ether-Functionalized Polyurethane

1.96 g (4.5 mmol) of the vinyl ether polyol synthesized in example 1 and 18.00 g (9 mmol) polypropylene glycol were provided in a 50-ml flask, degassed under reduced pressure at 75° C. and rinsed with nitrogen. 3.05 g (18.1 mmol) HDI and 0.0127 g dimethyltin dineodecanoate was then added at 15° C., and the mixture was slowly warmed to 80° C. The progress of the reaction was controlled by means of IR spectroscopy until the desired NCO value was achieved.

The reaction took place according to the following reaction scheme:

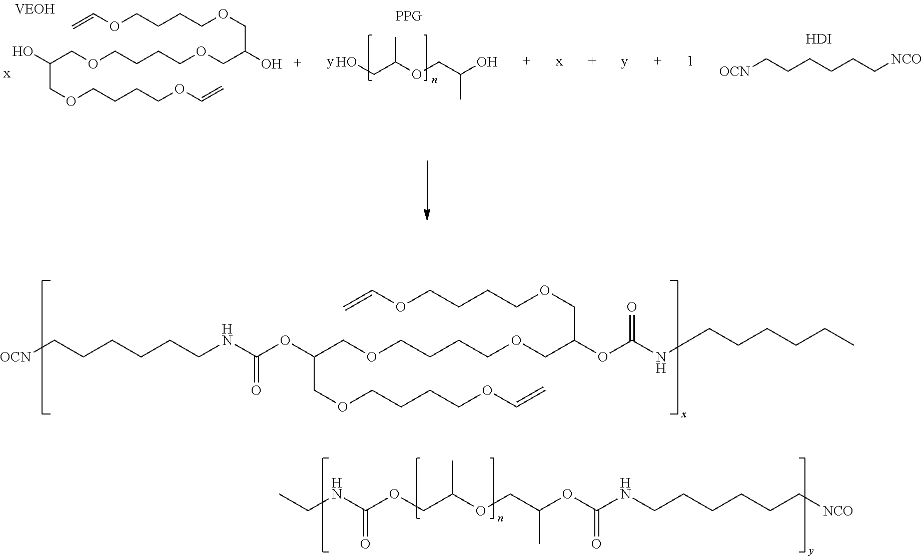

### Example 3

### Curing of Vinyl-Ether-Functionalized Polyurethane

The curing took place as follows: 0.23 g 4,4′-dimethyl-diphenyliodonium hexafluorophosphate was added to the polyurethane from example 2 at 40° C. under vigorous stirring. Dissolved gases were removed under reduced pressure, and a small glass container was filled to the brim with the sample and tightly sealed. The formulation then underwent UV- and NIR-coupled rheological tests in an Anton Paar MCR 302 rheometer that was coupled to a Bruker MPA FT-NIR spectrometer and an Omnicure S2000SC light source, both of which were activated by means of the rheometer software. For this purpose, the sample was provided in the middle of the quartz base plate and an aluminum plate having a diameter of 25 mm was used as a mobile cover plate having an initial gap of 0.3 mm. A normal force of 0 was applied for automatic gap control during shrinking of the sample in order to avoid additional stress or delamination. An increasing measurement profile was applied in order to ensure linear viscoelastic behavior and to keep said behavior within the instrument limits, since the modules of the sample increase by several orders of magnitude during curing. Oscillation measurements were carried out with a deformation of 0.1%, a frequency of 10 Hz and an initial gap of 0.3 mm with an applied normal force of Fn=0 N. The measurement cell was rinsed with instrument air (water content=1.1 mg/m³) and tempered to 60° C. Mechanical data were recorded every 5 seconds before radiation and every second during and following radiation. NIR spectra were recorded at a rate of approximately two spectra per second. The light source was automatically switched on after 30 s for 50 s (189 mW cm⁻² UVA-C). After 1,800 s (30 min) the measurement cell was opened and the rinsing with instrument air was stopped in order to allow moisture diffusion. Mechanical data were recorded every 60 s, and NIR spectra were recorded every 15 min for a further 120 h.

### BRIEF DESCRIPTION OF THE DRAWINGS

FIG. 1 shows the complex viscosity and the loss factor of the sample over time, the timescale being represented logarithmically in order to show that, while the cationic polymerization takes place in seconds, the moisture-curing takes place over hours or even several days. The cationic curing increases the complex viscosity by more than two orders of magnitude and induces gelling of the sample, which is indicated by the loss factor (tan (δ)=1 sol-gel transition). The plateau of the viscosity curve shows the conclusion of this reaction, with the subsequent slow increase resulting from the diffusion of moisture into the sample and the resulting curing of the isocyanate groups.

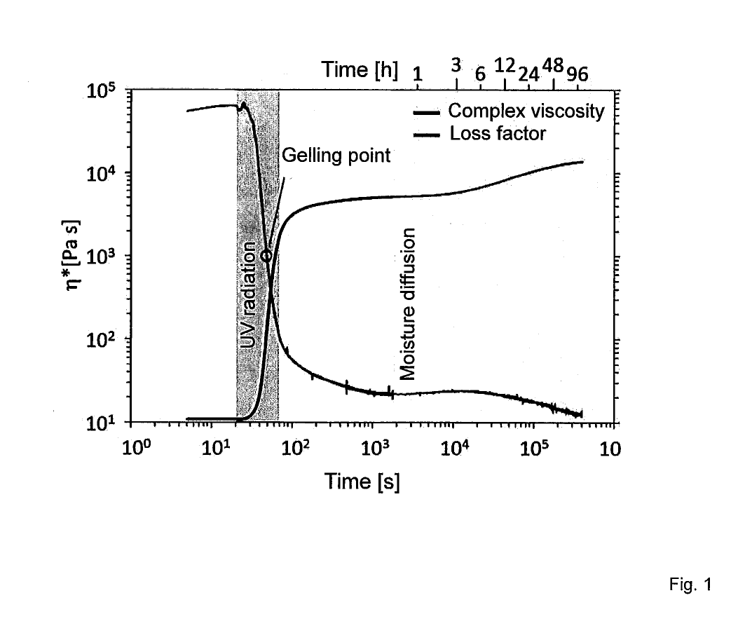

1. A polyurethane polymer having at least one alkenyl ether group-containing side chain and at least one moisture-reactive end group selected from an isocyanate group (—NCO) or a silicon-containing end group of formula —[(CH₂)ₚ—Si(R¹)_{3-q}(OR²)_{q}]ᵣ
where p, q and r=1, 2 or 3,
R¹=C₁₋₄ alkyl or —(CH₂)ₚ—Si(R¹)_{3-q}(OR²)_{q} and
R²=C₁₋₄ alkyl.

2. The polyurethane polymer according to claim 1, wherein the polyurethane polymer comprises terminal isocyanate moisture reactive groups and the polyurethane polymer is the reaction product of i) at least one alkenyl ether polyol containing at least one 1-alkenyl ether group and at least two hydroxyl groups (—OH) and ii) at least one polyether polyol and iii) at least one polyisocyanate containing at least two isocyanate groups.

3. The polyurethane polymer according to claim 1, wherein the alkenyl ether groups are vinyl ether groups.

4. The polyurethane polymer according to claim 1 wherein the moisture-reactive end group is the silicon-containing end group of formula —[(CH₂)ₚ—Si(R¹)_{3-q}(OR²)_{q}]ᵣ.

5. Cross-linked reaction products of the polyurethane polymer of claim 1.

6. An adhesive composition, a sealant composition or a coating agent composition comprising at least one polyurethane polymer according to claim 1.

7. A two-stage process for cross-linking a polyurethane polymer having at least one alkenyl ether group and at least one moisture-reactive end group selected from isocyanate group (—NCO) or silane group of formula —[(CH₂)ₚ—Si(R¹)_{3-q}(OR²)_{q}]ᵣ
where p, q and r=1, 2 or 3,
R¹=C₁₋₄ alkyl or —(CH₂)ₚ—Si(R¹)_{3-q}(OR²)_{q} and
R²=C₁₋₄ alkyl,
comprising:
cationically cross-linking the alkenyl ether groups by exposure to radiation and,
polymerizing the moisture-reactive groups by exposure to moisture.

8. A two-stage process of claim 6 wherein wherein the step of cross-linking the alkenyl ether groups takes place in the presence of a photoinitiator.

9. A method of making a polyurethane polymer having at least one alkenyl ether group-containing side chain and moisture-reactive end groups selected from isocyanate groups (—NCO) or silicon-containing end groups of formula —[(CH₂)_{p—Si(R}¹)_{3-q}(OR²)_{q}]ᵣ
where p, q and r=1, 2 or 3,
R¹=C₁₋₄ alkyl or —(CH₂)ₚ—Si(R¹)_{3-q}(OR²)_{q} and
R²=C₁₋₄ alkyl; comprising
providing at least one alkenyl ether polyol containing at least one alkenyl ether group and at least two hydroxyl groups (—OH);
providing at least one polyisocyanate containing at least two isocyanate groups (—NCO);
reacting the at least one alkenyl ether polyol with the at least one polyisocyanate to obtain an NCO-terminated polyurethane, wherein the polyisocyanate, with respect to the isocyanate groups, is used in molar excess relative to the hydroxyl groups; and
optionally reacting the NCO-terminated polyurethane with a silane of formula X—[(CH₂)ₚ—Si(R¹)_{3-q}(OR²)_{q}]ᵣ, where
X is an NCO-reactive group,
p, q and r=1, 2 or 3,
R¹=C₁₋₄ alkyl or —(CH₂)ₚ—Si(R¹)_{3-q}(OR²)_{q} and
R²=C₁₋₄ alkyl.

10. The method of claim 9 wherein X is an amino group or a hydroxyl group.

11. The method of claim 9 wherein the step of providing at least one alkenyl ether polyol comprises:
a) reacting an alkenyl ether containing at least one alkenyl ether group and at least one functional group selected from —OH, —COOH, —SH, —NH₂ and derivatives thereof, with (i) an epoxide or derivative thereof or (ii) a cyclic carbonate or derivative thereof; or
b) reacting an alkenyl ether, containing at least one alkenyl ether group and at least one functional group selected from (i) an epoxide group or derivative thereof and (ii) a cyclic carbonate group or derivatives thereof, with an alcohol, thiol, a carboxylic acid, or an amine or derivatives thereof.

12. The method of claim 9 wherein the step of providing at least one alkenyl ether polyol comprises:
providing (i) an epoxide or derivative thereof or (ii) a cyclic carbonate or derivative thereof;
providing an alkenyl ether containing at least one alkenyl ether group and at least one functional group selected from —OH, —COOH, —SH, —NH₂ and derivatives thereof, wherein the alkenyl ether polyol is an alkenyl ether polyol of formula (I) 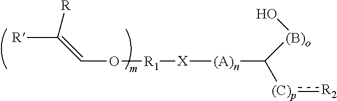
where
R₁ is a divalent linear or branched, substituted or unsubstituted alkyl having 1 to 20 carbon atoms; or a linear or branched, substituted or unsubstituted heteroalkyl having 1 to 20 carbon atoms and at least one oxygen or nitrogen atom,
R₂ is an organic group, optionally having at least one —OH group and/or 1 to 1000 carbon atoms; or a branched, substituted or unsubstituted alkyl having 1 to 20 carbon atoms; or a linear or branched, substituted or unsubstituted heteroalkyl having 1 to 20 carbon atoms and at least one oxygen or nitrogen atom;
X is O, S, C(═O)O, OC(═O)O, C(═O)OC(═O)O, NRₓ, NRₓC(═O)O, NRₓC(═O)NRₓ or OC(═O)NRₓ,
each R and R′ is independently selected from H, C₁₋₂₀ alkyl and C₂₋₂₀ alkenyl; or one of R and R′ is H and the other is C₁₋₄ alkyl; or both R and R′ are H,
each A, B and C is independently selected from CR″R′″,
R″ and R′″ are independently selected from H, a functional group, an organic group, and C₁₋₂₀ alkyl; or R″ and R′″ together or with the carbon atom to which they are bonded are an organic group; or two of R″ and R′″ that are bonded to adjacent carbon atoms together form a bond in order to form a double bond between the adjacent carbon atoms; [symbol]
represents a single or double bond, wherein, if it is a double bond the carbon atom that is bonded to R₂ bears only one substituent R″ or R′″,
m is an integer of from 1 to 10, preferably 1,
n, p, and o are each 0 or an integer of from 1 to 10, where n+p+o=1 or more, and
Rₓ is H, an organic group or 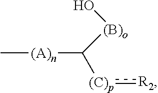
wherein if Rₓ is not 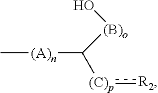
R₂ comprises at least one substituent that is selected from —OH and 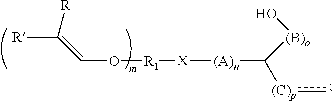
and
reacting the (i) an epoxide or derivative thereof or (ii) a cyclic carbonate or derivative thereof and the alkenyl ether to form the at least one alkenyl ether polyol.

13. The method of claim 9 wherein the step of providing at least one alkenyl ether polyol comprises:
providing an alcohol, thiol, carboxylic acid or amine or derivative of any of these;
providing an alkenyl ether containing at least one alkenyl ether group and at least one functional group selected from (i) epoxide groups or derivatives thereof and (ii) cyclic carbonate groups or derivatives thereof, the alkenyl ether having formula (V) 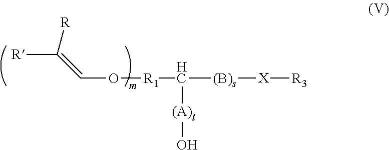
where
R₁ is a divalent organic group; or a divalent linear or branched, substituted or unsubstituted alkyl having 1 to 20 carbon atoms; or a linear or branched, substituted or unsubstituted heteroalkyl having 1 to 20 carbon atoms and at least one oxygen or nitrogen atom;
R₃ is an organic group having 1 to 1000 carbon atoms; or a linear or branched, substituted or unsubstituted alkyl having 1 to 20 carbon atoms; or a linear or branched, substituted or unsubstituted heteroalkyl having 1 to 20 carbon atoms and at least one oxygen or nitrogen atom; or a (poly)alkylene glycol group of formula —O—[CHRₐCH₂O]_{b}—R_{b},
where Rₐ is H or a C₁₋₄ alkyl group;
R_{b} is H or 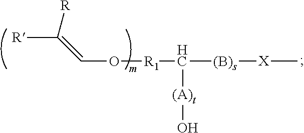
b is 1 to 100;
X is O, S, OC(═O), OC(═O)O, OC(═O)OC(═O), NR_{z}, NR_{z}C(═O)O, NR_{z}C(═O)NR_{z} or OC(═O)NR_{z},
R_{z} is H, an organic group or 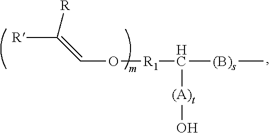
wherein if R_{z} is not 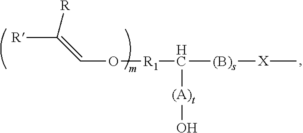
than R₃ comprises at least one substituent that is selected from —OH and 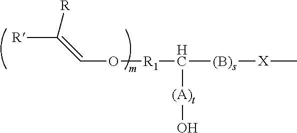
each R and R′ is independently selected from H, C₁₋₂₀ alkyl and C₂₋₂₀ alkenyl; or one of R and R′ is H and the other is C₁₋₄ alkyl; or both R and R′ are H;
each A and B is independently selected from C″R″R′″,
R″ and R′″ are independently selected from H, a functional group, an organic group, a C₁₋₂₀ alkyl group; or R″ and R′″ together or with the carbon atom to which they are bonded are an organic group; or two of R″ and R′″ that are bonded to adjacent carbon atoms together form a bond in order to form a double bond between the adjacent carbon atoms,
m is an integer of from 1 to 10, and
s and t are each 0 or an integer from 1 to 10, where s+t=1 or more; and
reacting the alcohol, thiol, carboxylic acid or amine or derivative thereof and the alkenyl ether to form the at least one alkenyl ether polyol.

13. The method according to claim 8, wherein the alkenyl ether groups in the at least one alkenyl ether polyol are vinyl ether groups.

14. The method according to claim 8, wherein the polyurethane polymer comprises terminal isocyanate moisture reactive groups and further comprising the step of providing at least one polyether polyol; and wherein the step of reacting comprises reacting the at least one alkenyl ether polyol containing at least one 1-alkenyl ether group and at least two hydroxyl groups (—OH) and the at least one polyether polyol and the at least one polyisocyanate containing at least two isocyanate groups.
